(19) United States
(12) Patent Application Publication
(10) Pub. No.: US 2026/0032191 A1
(43) Pub. Date: Jan. 29, 2026

(54) CAPTIONED TELEPHONE SERVICE SYSTEM FOR USER WITH SPEECH DISORDER

(71) Applicant: Mezmo Corporation, Irvine, CA (US)

(72) Inventor: Haesung LEE, Irvine, CA (US)

(21) Appl. No.: 19/348,519

(22) Filed: Oct. 2, 2025

Related U.S. Application Data
(63) Continuation-in-part of application No. 18/195,668, filed on May 10, 2023.

(51) Int. Cl. H04M 3/42; G10L 13/02

(52) U.S. Cl. CPC H04M 3/42; G10L 13/02; H04M 2201/40

(57) ABSTRACT

A captioned telephone service system is provided for assisting users with speech disorders in communicating with peers. The system comprises a CTS server, a user device, and a user application configured with a sentence refinement unit and a text-to-speech handler. The user inputs one or more words, which are processed by the sentence refinement unit to correct errors, insert missing grammar, and generate grammatically complete sentences. A contextual adaptation module analyzes conversation and peer information to select the most relevant sentence. The user confirms, regenerates, or edits the sentence, which is then converted to natural speech by the text-to-speech handler and transmitted to the peer's device. The system further employs user and peer databases to learn from prior interactions, thereby improving accuracy and facilitating effective communication for speech-impaired individuals.

### CROSS-REFERENCE TO RELATED APPLICATIONS

This application is a continuation-in-part of and claims priority to U.S. patent application Ser. No. 18/195,668, filed on May 10, 2023.

### FIELD OF THE INVENTION

The present invention relates to a captioned telephone service (CTS) system designed for users who are deaf or hard of hearing (DHH) and also have a speech disorder. A conventional CTS system provides a transcription service during a phone call by converting the peer's spoken voice into text, which is then displayed on the DHH user's device. However, when the user has a speech disorder and struggles to produce complete sentences, the peer may have difficulty understanding the user's speech. The present invention addresses this problem by enabling the CTS system to accept the user's written input, even if incomplete, refine it into a grammatically complete and contextually appropriate sentence, and then convert the refined sentence into speech for playback to the peer. More specifically, the CTS system refines the user's text input into a grammatically correct and contextually appropriate sentence for the user's confirmation, and, upon confirmation, converts the refined text into speech that is transmitted to the peer's device.

### BACKGROUND OF THE INVENTION

A captioned telephone service, also known as CTS (herein after referred to as “CTS”, “captioned telephone service”, or “transcription service”), is used to assist individuals, particularly those who are deaf or hard of hearing (“DHH”) but can speak, in making phone calls. A CTS system enables a DHH user (the CTS user) to have a phone call with another person (a peer) who may or may not be DHH by receiving the peer's voice, transcribing it into caption data, and sending the caption data to the CTS user's device for display as text.

The CTS user's device may be the user's own communications device such as a mobile wireless device, mobile phone, smart phone, landline phone, etc., or a terminal provided by a CTS provider. The user can make or receive calls using a user application installed on their device, and receive the transcription services from the CTS server.

However, some DHH individuals also have speech disorders or impairments. If hearing or speech impairment occurs before completion of primary education-before full language acquisition—these individuals may struggle to form complete sentences or produce accurate pronunciation during conversation. Even when impairment develops later, the longer the condition persists, the more pronunciation tends to deviate from that of a person with normal hearing, as self-correction is difficult without auditory feedback. Although many DHH individuals practice extensively to approximate socially accepted pronunciations, the process requires significant effort and is inherently limited. As a result, verbal communication is often unclear to the peer on the other end of a call.

For DHH users with speech disorders, CTS is more convenient if it incorporates a text-to-speech (TTS) handler that allows the user to type text, which the system then converts into audio for playback to the peer. Yet many DHH individuals also face challenges in constructing grammatically correct sentences. In particular, those whose impairment occurred before completion of elementary language education often rely on word-based communication consisting largely of nouns and verbs, with limited adjectives and minimal use of adverbs, particles, or function words. Consequently, when such users communicate with non-disabled peers using spoken or written language, their output is often ungrammatical and difficult to understand.

When a speech-impaired user employs a CTS system with TTS functionality, grammatically incorrect or word-centered input results in equally flawed TTS output. Typographical or phonetic errors in the user's input are also reproduced in the generated speech, further hindering comprehension. This leads to communication breakdown, confusion for the peer, and frustration and limitation for the user.

Accordingly, there is a need for an improved communication system capable of refining or restructuring a user's input into grammatically correct sentences before converting the input into speech, thereby facilitating smooth communication between a user with a speech disorder and a peer. The present invention is directed to solving these problems and addressing this long-felt need.

### SUMMARY OF THE INVENTION

The present invention contrives to solve the disadvantages of the prior art. The present invention provides a CTS system for a user who is DHH and also has a speech disorder. The CTS system refines the user's text input into a grammatically complete and contextually appropriate sentence for the user's confirmation and, upon confirmation, converts the refined sentence into speech for transmission to the peer's device.

The invention provides a CTS system comprising a sentence refinement unit integrated with both a user application and a CTS server. The user application allows a speech-impaired user to input one or more words through text or voice. The sentence refinement unit processes the input, detects typographical or phonetic errors, corrects them, and generates grammatically complete candidate sentences. A contextual adaptation module analyzes context information—such as prior conversation history, peer information, or user databases—to select the most contextually relevant sentence.

The refined sentence is then presented to the user for confirmation, regeneration, or editing. Once confirmed, the refined sentence is converted into speech by a text-to-speech (TTS) handler, which may include prosody adjustment for natural intonation. The resulting speech or its playback is transmitted to the peer's device. The system further comprises user and peer databases for storing historical inputs, confirmed refinements, and conversation metadata. By analyzing this data, the refinement unit can improve its accuracy and contextual relevance over time.

Through this approach, the invention enables speech-impaired individuals to communicate effectively with grammatically correct and contextually relevant sentences, thereby overcoming the limitations of conventional CTS and relay systems.

The object of the present invention is to provide a CTS system for a DHH user with a speech disorder where the CTS system includes a CTS server for providing a transcription service to the user during a phone call between the user and a peer; a user's device, which is constructed to be connected to the CTS server for the phone call between the user's device and a peer's device; and a user application installed on the user's device. The CTS system further includes a sentence refinement unit and a text-to-speech handler. The user application is configured to allow the user to input a sentence, which is comprised of one or more words, and send the sentence to the sentence refinement unit to refine the sentence into a refined sentence, and the text-to-speech handler is configured to receive the refined sentence from the sentence refinement unit and convert the refined sentence into a speech which is then transmitted to the peer's device.

Another object of the present invention is to provide a user's device to receive a transcription service and a speech-to-text and text-to-speech converting service for the user, who is DHH and has a speech disorder, during a phone call between the user and the peer by using the CTS system. The CTS system for a user with a speech disorder, includes a CTS server for providing a transcription service to the user during a phone call between the user and a peer; a user's device, which is constructed to be connected to the CTS server for the phone call between the user's device and a peer's device; a user application installed on the user's device; and a sentence refinement system, which is connected to the user's device and the CTS server for the phone call between the user's device and the peer's device. The CTS system further comprises a text-to-speech handler. The user application is configured to allow the user to input a sentence, which is comprised of one or more words, and send the sentence to the sentence refinement system to refine the sentence into a refined sentence, and the text-to-speech handler is configured to receive the refined sentence from the sentence refinement system and convert the refined sentence into a speech which is then transmitted to the peer's device.

The advantages of the present invention are: (1) The CTS system of the present invention ensures that fragmented or grammatically incorrect input from a speech-impaired user is refined into clear, grammatically correct sentences, greatly improving peer comprehension; (2) the CTS system of the present invention detects and corrects typographical and phonetic errors automatically so that the user's intended meaning is preserved; (3) the CTS system of the present invention adapts refined sentences to the conversational context, using prior dialogue and peer information to produce more accurate and appropriate communication; (4) the system gives the user control to confirm, regenerate, or edit the refined sentence, ensuring that the final message reflects the user's intent; (5) the text-to-speech handler delivers the refined sentences in natural-sounding speech, improving the quality of the conversation for the peer; (6) a user database stores past inputs and refinements to allow the system to learn from history and improve accuracy over time; and (7) a peer database maintains conversation patterns and peer attributes, which helps tailor sentence refinements to specific communication partners.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a block diagram of a conventional CTS or IP Relay communication system;

FIG. 2 shows a block diagram of a CTS or IP Relay communication system including a sentence refinement module, text-to-speech handler, user database, and peer database according to the present invention;

FIG. 3 shows an embodiment where the sentence refinement system is implemented as a separate module connected between the user's device and the CTS server;

FIG. 4 depicts an example user interface where the user inputs a partial or ungrammatical sentence and the system refines the input into a grammatically correct candidate sentence; and

FIG. 5 illustrates a user interface providing options for confirmation, regeneration, and editing of the refined sentence before transmission via TTS.

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment. Additionally, in all of the embodiments detailed below, call forwarding includes call routing.

The invention relates to a captioned telephone service (“CTS”) system 100 that integrates a sentence refinement unit 500 with a CTS server 200, a user's device 300, and a peer's device 400. The system 100 includes a CTS server 200 that provides transcription and communication relay services, a user device 300 that includes a user application for sentence input, a peer device 400 that receives speech playback of refined sentences, a sentence refinement unit 500 that processes user input to generate grammatically complete sentences, and a text-to-speech handler 210 that converts refined sentences into natural speech with intonation control. The system 100 may further include a user database 230 that stores input and confirmed refined sentences, along with historical corrections, and a peer database 240 that stores peer information, conversation history, and communication style metadata.

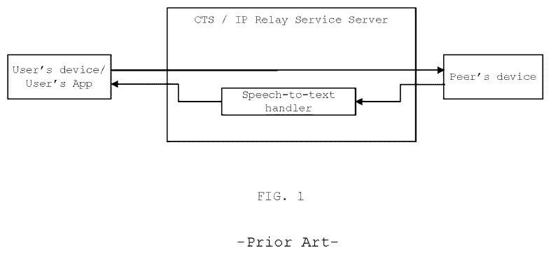

FIG. 1 shows a block diagram of a conventional CTS or IP Relay communication system. The CTS server transcribes the peer's voice into text and delivers the transcribed text to the user, while also transmitting the user's voice to the peer.

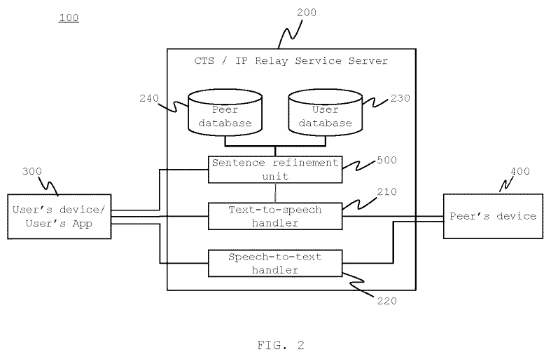

FIG. 2 shows a communication environment in which the CTS server 200 interacts with the user device 300 and the peer device 400. The user device 300 includes a user application through which the user can input sentences. The system 100 further comprises a sentence refinement unit 500 and a text-to-speech handler 210. The sentence refinement unit 500 is responsible for receiving the user's input and correcting it into a grammatically complete and contextually appropriate sentence before it is converted into speech.

The system 100 further includes a speech-to-text handler 220, a user database 230, and a peer database 240. The user database 230 stores both raw input sentences and refined sentences confirmed by the user, along with historical corrections, so that the system 100 can learn refinement rules over time. The peer database 240 stores information related to peers, such as conversation history, the kind of business, and typical communication patterns, enabling the system 100 to improve contextual accuracy.

In operation, the user inputs a sentence through the application. The sentence refinement unit 500 processes the input by correcting errors and restructuring it into a complete sentence. The refined sentence is then forwarded to the text-to-speech handler 210, which converts the refined text into natural speech output. This audio is transmitted to the peer's device 400 so that the peer can hear a grammatically correct and understandable sentence.

The CTS system 100 for a user with a speech disorder includes: a CTS server 200 for providing a transcription service to the user during a phone call between the user and a peer; a user's device 300, which is constructed to be connected to the CTS server 200 for the phone call between the user's device 300 and a peer's device 400; and a user application installed on the user's device 300. The CTS system 100 further comprises a sentence refinement unit 500 and a text-to-speech handler 210. The user application is configured to allow the user to input a sentence, which is comprised of one or more words, and send the sentence to the sentence refinement unit 500 to refine the sentence into a refined sentence, and the text-to-speech handler 210 is configured to receive the refined sentence from the sentence refinement unit 500 and convert the refined sentence into a speech. The speech or its playback (collectively referring to as the “speech”) is then transmitted to the peer's device 400.

The sentence refinement unit 500 may include a word accuracy module, which is configured to detect and correct typographical or phonetic errors in the one or more words. The sentence refinement unit 500 may further include a sentence structuring module, which converts the sentence into a grammatically complete sentence by inserting grammatically missing words and grammatically modifying the one or more words.

Furthermore, the sentence refinement unit 500 may include a contextual adaptation module, which analyzes context information and modifies the sentence to reflect the context information. The sentence refinement unit 500 may produce just one refined sentence, or two or more refined sentences for selection by the contextual adaptation module or the user. The context information may be constructed based on conversation between the user and the peer and a phone number of the peer.

In one embodiment, the sentence refinement unit 500 may include a sentence structuring module and a contextual adaptation module. The sentence structuring module converts the sentence into a grammatically complete sentence by inserting grammatically missing words and grammatically modifying the one or more words, and the sentence structuring module may generate two or more grammatically complete sentences. The contextual adaptation module analyzes a context information and selects, from the two or more grammatically complete sentences, a grammatically complete sentence out of the two or more grammatically complete sentences that most accurately reflects the context information. In the alternative embodiment, the contextual adaptation module may revise the sentence generated by the sentence structuring module.

The CTS system 100 may further include a user database 230 associated with the user, which stores the original input sentences and the corresponding refined sentences confirmed by the user, as well as historical corrections. The sentence refinement unit 500 is configured to learn refinement rules from the stored data to improve the accuracy of future refinements.

In addition, the CTS system 100 may include a peer database 240 associated with the peer, which stores phone conversation records, information about the peer's business, and typical communication patterns or styles. The contextual adaptation module may reference the peer database 240 to improve the contextual relevance of sentence refinements.

By analyzing the data stored in both the user database 230 and the peer database 240, the sentence refinement unit 500 is configured to continuously learn and enhance refinement rules, thereby improving the accuracy and contextual appropriateness of future refinements.

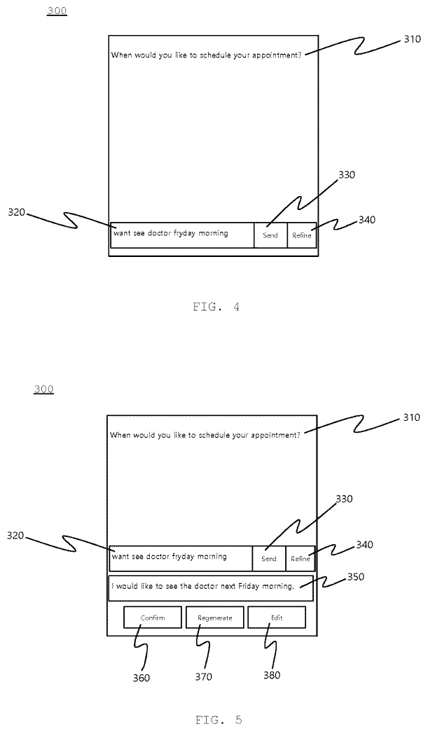

FIG. 4 is a diagram illustrating an example of a user interface provided on the user's device 300 in which the user inputs an incomplete or grammatically incorrect sentence 320. FIG. 5 is a diagram illustrating an embodiment of a user interface that provides control options for managing refined sentences 350.

The user application 300 is configured to display the refined sentence 350 and provide a user interface control comprising a “confirm” button 360, where upon activation of the “confirm” button 360, the refined sentence 350 is converted into the speech by the text-to-speech handler 320 which is transmitted to the peer's device 400.

The user interface control may further include a “regenerate” button 370, where upon activation of the “regenerate” button 370, the sentence refinement unit 500 generates a new refined sentence which is different from the refined sentence, the user application 300 being configured to display the new refined sentence. Furthermore, the user interface control further comprises an “edit” button 380, where upon activation of the “edit” button 380, the user application 300 enables editing of the refined sentence. Editing allows the user to manually revise the refined sentence, and it may further allow the user to reorder words, modify verb tense, or select an alternative version.

The text-to-speech handler 210 may include a prosody adjustment module configured to generate speech with natural intonation, pacing, and emphasis, and may be further configured to adapt speech characteristics based on a stored user profile. The user application 300 may further comprise a predictive phrase suggestion module configured to proactively suggest sentences or phrases based on historical usage, current conversational context, or partial user input.

As shown in FIGS. 4 and 5, the interface displays both the raw input text 320 and one or more refined candidate sentences 350 generated by the sentence refinement unit 500. In response to the peer's speech, “When would you like to schedule your appointment?” 310, the user enters raw input text 320 and may then press either the “send” button 330 or the “refine” button 340. The user is able to review the refined output before it is converted into speech. For example, when the user inputs a phrase such as “want see doctor fryday morning” 320, the interface also displays the refined version “I would like to see the doctor next Friday morning” 350, which is generated by the sentence refinement unit 500. The interface thereby enables the user to visually confirm that the corrected and grammatically complete sentence accurately reflects the intended meaning.

As shown in FIG. 5, the interface displays the refined sentence 350 and includes selectable controls such as a “confirm” button 360, a “regenerate” button 370, and an “edit” button 380. When the confirm button 360 is activated, the refined sentence 350 is transmitted to the text-to-speech handler 210 for conversion into speech and subsequent playback to the peer's device 400. When the regenerate button 370 is activated, the sentence refinement unit 500 produces an alternative refinement of the user's original input. When the edit button 380 is selected, the refined sentence becomes editable so that the user may manually edit the sentence 350, reorder words, change verb tense, or insert additional words. This interface provides the user with flexibility and control to ensure that the sentence ultimately transmitted to the peer is accurate, natural, and contextually appropriate.

The sentence refinement unit 500 includes a word accuracy module that detects and corrects typographical and phonetic errors, such as “fryday” being corrected to “Friday.” A sentence structuring module then inserts missing words and modifies input to form a grammatically complete sentences, for example refining “want see doctor Friday morning” into “I would like to see the doctor Friday morning.” A contextual adaptation module analyzes context such as peer identity, prior conversation, or databases, and selects the most contextually appropriate sentence among multiple candidates. Alternatively, the contextual adaptation module may revise the sentence, for example revising into “I would like to see the doctor next Friday morning.”

In an alternative embodiment, the sentence refinement unit may be incorporated into the user's device, either within or outside the user application. Similarly, the user database and/or the peer database may also be implemented on the user's device, either within or outside the user application.

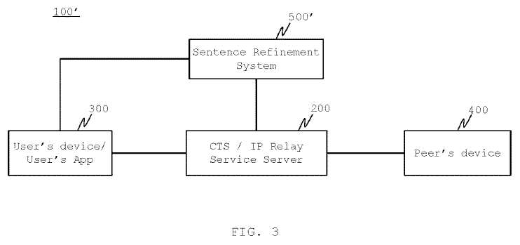

FIG. 3 is a block diagram illustrating another embodiment of the CTS system 100′ in which the sentence refinement unit 500 is implemented as a separate functional unit of the sentence refinement system 500′ between the user's device 300 and the CTS server 200. In this configuration, the user's device 300 transmits a sentence input to the sentence refinement system 500′ rather than directly to the CTS server 200. The sentence refinement system 500′ processes the input to detect typographical and phonetic errors, restructure the input into a grammatically complete sentence, and adapt the sentence based on contextual information obtained from a user database 230 and a peer database 240.

Once the refinement is complete, the refined sentence is passed to a text-to-speech handler 210, which generates a speech signal corresponding to the refined sentence. The generated speech is then transmitted to the peer's device 400, while the CTS server maintains its normal function of providing captioned or relay services.

This embodiment emphasizes modularity by separating the sentence refinement unit as a system 500′ from the CTS server 200, thereby allowing the refinement process to be deployed as an independent module that can be integrated with existing CTS or IP Relay systems without requiring modification of the server itself.

The CTS system 100′ for a user with a speech disorder includes: a CTS server 200 for providing a transcription service to the user during a phone call between the user and a peer; a user's device 300, which is constructed to be connected to the CTS server 200 for the phone call between the user's device and a peer's device; a user application installed on the user's device 300; and a sentence refinement system 500′, which is connected to the user's device 300 and the CTS server 200 for the phone call between the user's device 300 and the peer's device 400. The CTS system 100′ further comprises a text-to-speech handler 210 and a speech-to-text handler 220.

The user application 300 is configured to allow the user to input a sentence, which is comprised of one or more words, and send the sentence to the sentence refinement system 500′ to refine the sentence into a refined sentence, and the text-to-speech handler 210 is configured to receive the refined sentence from the sentence refinement system 500′ and convert the refined sentence into a speech which is then transmitted to the peer's device 400.

The sentence refinement system 500′ comprises a sentence structuring module and a contextual adaptation module, where the sentence structuring module converts the sentence into a grammatically complete sentence by inserting grammatically missing words and grammatically modifying the one or more words, and the sentence structuring module generates two or more grammatically complete sentences. The contextual adaptation module analyzes a context information and selects, from the two or more grammatically complete sentences, a grammatically complete sentence out of the two or more grammatically complete sentences that most accurately reflects the context information.

The CTS system 100′ may further comprise a user database 230, which is associated with the user and stores the sentence and the refined sentence which is confirmed by the user, and a peer database 240, which is associated with the peer and stores phone conversations with the peer.

The sentence refinement system 500′ is configured to learn and improve refinement rules by analyzing data stored in the user database 230 and the peer database 240 for improving accuracy and relevancy of future refinements. The user application 300 is configured to display the refined sentence 350 and provide a user interface control comprising a “confirm” button 360 and an “edit” button 380. Upon activation of the “confirm” button 360, the refined sentence is converted into the speech by the text-to-speech handler 210 which is transmitted to the peer's device 400, and upon activation of the “edit” button 380, the user application 300 enables editing of the refined sentence 350.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A captioned telephone service (“CTS”) system for a user with a speech disorder, comprising:
a CTS server for providing a transcription service to the user during a phone call between the user and a peer;
a user's device, which is constructed to be connected to the CTS server for the phone call between the user's device and a peer's device; and
a user application installed on the user's device,
wherein the CTS system further comprises a sentence refinement unit and a text-to-speech handler,
wherein the user application is configured to allow the user to input a sentence, which is comprised of one or more words, and send the sentence to the sentence refinement unit to refine the sentence into a refined sentence, and
wherein the text-to-speech handler is configured to receive the refined sentence from the sentence refinement unit and convert the refined sentence into a speech which is then transmitted to the peer's device.

2. The CTS system of claim 1, wherein the sentence refinement unit comprises a word accuracy module,
wherein the word accuracy module is configured to detect and correct typographical or phonetic errors in the one or more words.

3. The CTS system of claim 1, wherein the sentence refinement unit further comprises a sentence structuring module,
wherein the sentence structuring module converts the sentence into a grammatically complete sentence by inserting grammatically missing words and grammatically modifying the one or more words.

4. The CTS system of claim 1, wherein the sentence refinement unit comprises a contextual adaptation module,
wherein the contextual adaptation module analyzes context information and modifies the sentence to reflect the context information.

5. The CTS system of claim 4, wherein the context information is constructed based on conversation between the user and the peer and a phone number of the peer.

6. The CTS system of claim 1, wherein the sentence refinement unit comprises a sentence structuring module and a contextual adaptation module,
wherein the sentence structuring module converts the sentence into a grammatically complete sentence by inserting grammatically missing words and grammatically modifying the one or more words,
wherein the sentence structuring module generates two or more grammatically complete sentences,
wherein the contextual adaptation module analyzes a context information and selects, from the two or more grammatically complete sentences, a grammatically complete sentence out of the two or more grammatically complete sentences that most accurately reflects the context information.

7. The CTS system of claim 1, further comprising a user database, which is associated with the user and stores the sentence and the refined sentence which is confirmed by the user.

8. The CTS system of claim 1, further comprising a peer database, which is associated with the peer and stores phone conversations with the peer.

9. The CTS system of claim 1, comprising a user database and a peer database,
wherein the user database is associated with the user and stores the sentence and the refined sentence which is confirmed by the user,
wherein the peer database is associated with the peer and stores phone conversations with the peer,
wherein the sentence refinement unit is configured to learn and improve refinement rules by analyzing data stored in the user database and the peer database for improving accuracy and relevancy of future refinements.

10. The CTS system of claim 1, wherein the user application is configured to display the refined sentence and provide a user interface control comprising a “confirm” button,
wherein upon activation of the “confirm” button, the refined sentence is converted into the speech by the text-to-speech handler which is transmitted to the peer's device.

11. The CTS system of claim 10, wherein the user interface control further comprises a “regenerate” button,
wherein upon activation of the “regenerate” button, the sentence refinement unit generates a new refined sentence which is different from the refined sentence, the user application being configured to display the new refined sentence.

12. The CTS system of claim 10, wherein the user interface control further comprises an “edit” button,
wherein upon activation of the “edit” button, the user application enables editing of the refined sentence.

13. The CTS system of claim 1, wherein the text-to-speech handler comprises a prosody adjustment module configured to generate the speech having natural intonation, pacing, and emphasis.

14. The CTS system of claim 1, wherein the user application further comprises a predictive phrase suggestion module configured to proactively suggest sentences or phrases based on historical usage, current context, or partial user input.

15. A captioned telephone service (“CTS”) system for a user with a speech disorder, comprising:
a CTS server for providing a transcription service to the user during a phone call between the user and a peer;
a user's device, which is constructed to be connected to the CTS server for the phone call between the user's device and a peer's device;
a user application installed on the user's device; and
a sentence refinement system, which is connected to the user's device and the CTS server for the phone call between the user's device and the peer's device,
wherein the CTS system further comprises a text-to-speech handler,
wherein the user application is configured to allow the user to input a sentence, which is comprised of one or more words, and send the sentence to the sentence refinement system to refine the sentence into a refined sentence, and
wherein the text-to-speech handler is configured to receive the refined sentence from the sentence refinement system and convert the refined sentence into a speech which is then transmitted to the peer's device.

16. The CTS system of claim 15, wherein the sentence refinement system comprises a sentence structuring module and a contextual adaptation module,
wherein the sentence structuring module converts the sentence into a grammatically complete sentence by inserting grammatically missing words and grammatically modifying the one or more words,
wherein the sentence structuring module generates two or more grammatically complete sentences,
wherein the contextual adaptation module analyzes a context information and selects, from the two or more grammatically complete sentences, a grammatically complete sentence out of the two or more grammatically complete sentences that most accurately reflects the context information.

17. The CTS system of claim 15, further comprising a user database, which is associated with the user and stores the sentence and the refined sentence which is confirmed by the user.

18. The CTS system of claim 17, further comprising a peer database, which is associated with the peer and stores phone conversations with the peer.

19. The CTS system of claim 18, wherein the sentence refinement system is configured to learn and improve refinement rules by analyzing data stored in the user database and the peer database for improving accuracy and relevancy of future refinements.

20. The CTS system of claim 15, wherein the user application is configured to display the refined sentence and provide a user interface control comprising a “confirm” button and an “edit” button,
wherein upon activation of the “confirm” button, the refined sentence is converted into the speech by the text-to-speech handler which is transmitted to the peer's device,
wherein upon activation of the “edit” button, the user application enables editing of the refined sentence.
